(19) United States
(12) Patent Application Publication
(10) Pub. No.: US 2022/0035482 A1
(43) Pub. Date: Feb. 3, 2022

(54) Media Case Stylus

(71) Applicant: A Clean Corner Inc., Bronx, NY (US)

(72) Inventor: Ari Heller Williams, Bronx, NY (US)

(21) Appl. No.: 17/387,177

(22) Filed: Jul. 28, 2021

Related U.S. Application Data
(60) Provisional application No. 63/057,749, filed on Jul. 28, 2020.
(60) Provisional application No. 63/071,219, filed on Aug. 27, 2020.

(51) Int. Cl. G06F 3/044; G06F 3/0354; H04B 1/3888

(52) U.S. Cl. CPC G06F 3/0441; H04B 1/3888; G06F 3/0354

(57) ABSTRACT

A media device case for a media device is disclosed. The media device case allows a user to use the user's media device to interact with touchscreens of other devices. Thus, the user does not need to use his or her fingers or another separate device to interact with other touch screens. Since the media device case may have a corner made of antimicrobial material, the user does not need to maintain the media device case to remove any virus or bacteria that is on the corner of the media device case.

### CROSS-REFERENCE TO RELATED APPLICATIONS

This patent application claims the benefit of U.S. Provisional Application No. 63/057,749 filed on Jul. 28, 2020 and U.S. Provisional Application No. 63/071,219 filed on Aug. 27, 2020, each of which are incorporated by reference in their entirety.

### BACKGROUND

### 1. Field of Art

The present disclosure generally relates mobile media devices such as smartphones, and more specifically to conductive attachments for media devices.

### 2. Background

The rising concern regarding the spread of germs, viruses and bacteria caused by the Covid-19 pandemic has made completing everyday tasks increasingly uncomfortable. The daily lives of people require interaction with public surfaces, such as elevator buttons, laundry machines, vending machines, ATMs, point of sale (POS) systems, and electronic point of sale (EPOS) systems, etc. Yet, despite growing germophobic concerns, people are continuously forced to either carry a stylus/other protective hand gear (e.g., gloves) with them at all times or use their hands directly to interact with surfaces. Conventional mechanisms do not protect individuals from interacting with germs as they demand often and thorough cleaning (of either hands or protective gear) which is usually not performed.

Moreover, conventional antimicrobial media device cases are either made from non-conductive materials or insufficient amounts of conductive materials. Conventional antimicrobial media device cases made of non-conductive materials still require users to use their hands to interact with touch sensitive display surfaces such as touch screens of an ATM or EPOS.

Similarly, conventional antimicrobial media device cases made of conductive materials like copper, brass, aluminum, steel, or silver merely include only a micro thin composite of the conductive material on the outermost layer of the media device cases in order to avoid radio wave interference and effectively turn the phone case into a “faraday cage.” Adding too much conductive material into the media device case blocks reception of any media devices placed within the media device cases. As a result, the outer layer of existing media cases has too little conductive material to effectively transfer charge and enable the case to act as a stylus on capacitive touch screens. Thus, these conventional media device cases with conductive material are used purely for antimicrobial reasons.

### SUMMARY

An embodiment of the disclosed media device case is a two-part innovation. The first part is the implementation and utilization of conductive materials for the intention of creating a conductive stylus media device case. The conductive media device case comprises a conductive material such as conductive thermoplastic thereby forming capacitive:charge the conductive media device case and a user's hand. By utilizing conductive materials for the conductive media device case, the entire conductive media device case becomes conductive and thus works as a stylus on touch sensitive devices that are capable of sensing touch.

In one embodiment, at least a portion of the conductive media device case is made from conductive materials allowing the entire case to act as a stylus. When a user holds the case, the natural charge from the user's hand transfers throughout the conductive media device case turning the entire conductive media device case into a working stylus for touch screens. Any part of the conductive media device case may be used to interact with a touch screen such that the interaction will be sensed as a touch of the touch screen by the touch sensitive device that includes the touch screen.

In one embodiment, the conductive media device case includes portions that are antimicrobial in order to reduce cross contamination resulting from the conductive media device case interacting with dirty surfaces like touch screens and buttons. Thus, a portion of the conductive media device case such as at least one corner of the conductive media device case is antimicrobial. In one embodiment, the whole conductive media device case is antimicrobial.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

FIGS. 1A and 1B illustrate various views of a conductive media device case according to a first embodiment.

FIG. 2 illustrates an interaction of the conductive media device case with a touch sensitive device according to the first embodiment.

FIGS. 3A, 3B, and 3C illustrate various views of a conductive media device case including a conductive attachment according to a second embodiment.

FIG. 4 illustrates a view of the conductive media device case with the conductive attachment removed according to the second embodiment.

FIG. 5 illustrates a view of a conductive media device case with a plurality of conductive attachments according to a third embodiment.

FIGS. 6 and 7 respectively illustrate interactions of the conductive media device case with touch sensitive devices and non-touch sensitive devices according to the second embodiment.

FIGS. 8 and 18-19 illustrate a crescent shaped corner attachment attached to a media device according to one embodiment.

FIGS. 9 to 16 illustrate different views of a “L” shaped corner attached configured to attach to a media device according to one embodiment.

FIGS. 17 illustrates a customizable logo on the crescent shaped corner attachment according to one embodiment.

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION

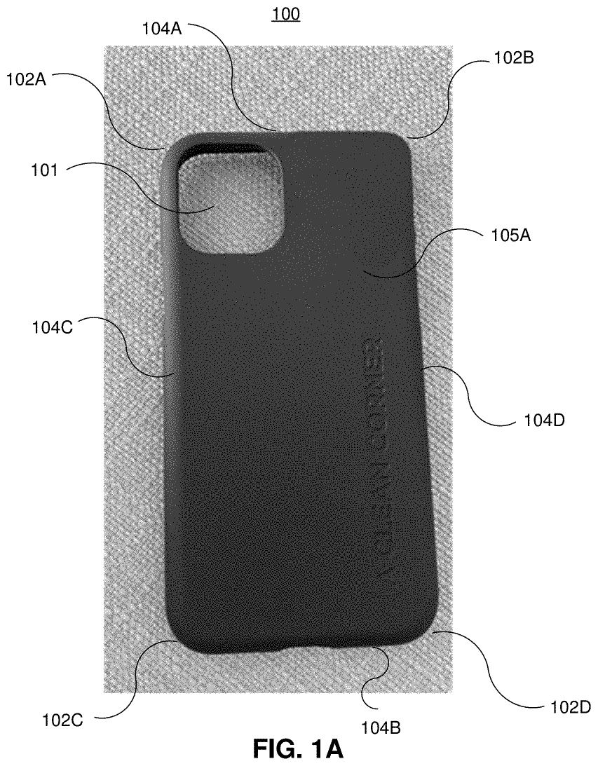

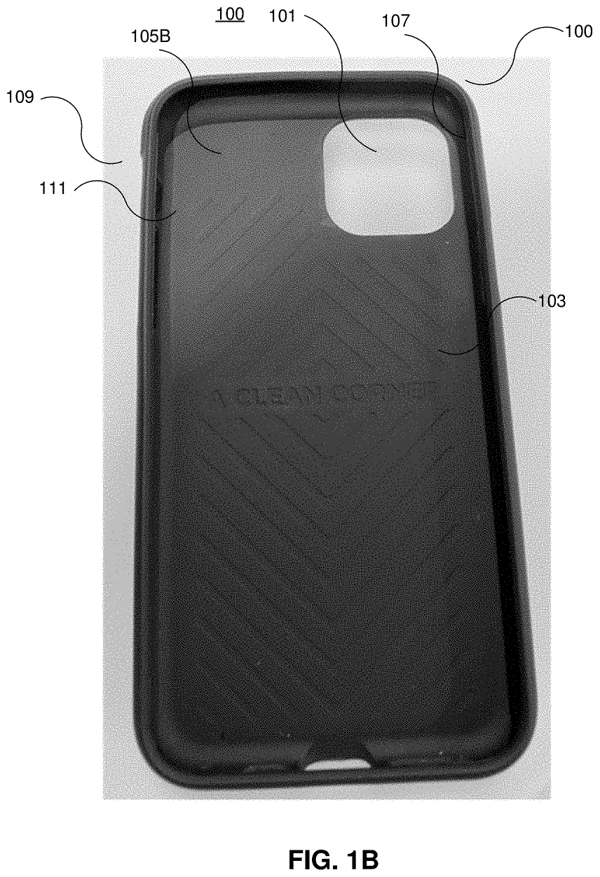

FIG. 1A illustrates a first embodiment of a conductive media case 100. In the first embodiment, the conductive media case 100 is made entirely of a conductive material such as conductive thermoplastic. Examples of a conductive thermoplastic include Thermoplastic Polyurethane that is combined with graphite fiber to create a conductive exterior that does not interfere with cell reception. The conductive media case 100 is configured to directly contact a surface of a media device while the media device is placed within the conductive media case 100. For example, the interior back and interior side surfaces of the media device are in direct contact with the conductive media case while the media device is placed in the conductive media case 100. Thus, the conductive media case 100 does not include an insulator between the media device and the conductive media case 100. An example of a media device is a mobile phone, but the media device may be a tablet computer, a MP3 player, or any type of mobile media device. As a result, the mix contains high amounts of carbon particles allowing for strong conductivity. At the same time it does not block radio waves

As a result of the direct contact between the conductive media case 100 and the media device, charge from a user that is holding the conductive media case 100 passes through the conductive media case 100 and the media device. When the conductive media case 100 is used to interact with a touch sensitive display device (e.g., a capacitive touch screen), a change in charge on the touch sensitive display device is sensed by the capacitive based touch sensitive display device and interpreted by the touch sensitive display device as a touch. Thus, the conductive media case 100 can be used to perform interactions with the touch sensitive display device that are recognized by the touch sensitive display device as a form of input into the touch sensitive display device.

FIG. 1A illustrates a back side of the conductive media case 100 according to the first embodiment. The conductive media case 100 includes a plurality of exterior corners 102. The exterior corners include an upper left exterior corner 102A, an upper right exterior corner 102B, a lower left exterior corner 102C, and a lower right exterior corner 102D. Between each pair of outer exterior corners is an exterior edge that connects together the pair of exterior corners. For example, upper exterior edge 104A connects together exterior corners 102A and 102B, lower exterior edge 104B connects together exterior corners 102C and 102D, left exterior edge 104C connects together exterior corners 102A and 102C, and right exterior edge 104D connects together corners 102B and 102D. In one embodiment, any of the exterior corners 102 and exterior edges 104 may be used as a stylus to interact with a touch sensitive display device such that the interaction is recognized by the touch sensitive display device as a touch.

In an alternative embodiment, a portion of the conductive media case 100 is made of conductive material and a portion of the conductive media case is made of non-conductive material. For example, the exterior corners 102A to 102D and exterior edges 104A to 104D that form the exterior perimeter of the conductive media case 100 are made of conductive material whereas the exterior back surface 105A from which the exterior corners 102 and exterior edges 104 extend is made of non-conductive material. For example, the exterior back surface 105A is made from an insulator material while the perimeter of the cases including all four exterior corners 102 and exterior edges 105 are made of conductive material. An example of the insulator material is thermoplastic without graphite fiber. Therefore, if the user is touching a part of the exterior perimeter of conductive media case 100, the entire perimeter becomes charged and usable on capacitive touch screens. The alternative embodiment allows a wider selection of insulator materials for the back surface 105, but still wants the perimeter of the media device case 100 to be an effective stylus.

FIG. 1B illustrates a front view of the conductive media case 100 according to the first embodiment. The body 109 of the conductive media case 100 includes a cavity 111 formed in the body 109. The cavity 111 allows the conductive media case 100 to house a media device while the media device is placed in the conductive media case 100. The size and shape of the cavity 111 is dependent on a size and shape of the media device that the conductive media case 100 is configured to house.

The conductive media device case 100 includes an interior back surface 105B and a plurality of interior side surfaces 107 that extend from the interior back surface 105 in a direction perpendicular to the inner back surface 105. The plurality of interior side surfaces 107 include an upper interior side surface, a lower interior side surface, a left interior side surface and a right interior side surface for example. In one embodiment, the interior back surface 105 and the plurality of interior side surfaces 107 of the conductive media case 100 are in direct contact with the media device while the media device is placed within the cavity 111 of the conductive media case 100.

In one embodiment, the interior back surface 10B is non-conductive due to being made of non-conductive material similar to the exterior back surface 105A described above and the interior side surfaces 107 are conductive due to being made of conductive material whereas the exterior back surface 105A and exterior perimeter (e.g., the exterior corners 102 and exterior edges 105) are conductive. In another embodiment, the interior back surface 105B and the interior side surfaces 107 are non-conductive due to being made of non-conductive material whereas the exterior back surface 105A and exterior perimeter (e.g., the exterior corners 102 and exterior edges 105) are conductive.

In one embodiment, a plurality of ridges 103 are formed on the interior back surface 105 of the conductive media case 100. The plurality of ridges 103 are raised surfaces on the interior back surface 105 of the conductive media case 100. The ridges 103 are configured to increase surface contact with the back of the media device so that the media device stays in place while disposed in the conductive media case 100. In one embodiment, the plurality of ridges 103 are formed in a pattern such as a diamond pattern and/or a line pattern.

In one embodiment, the conductive media case 100 includes a plurality of cut outs to expose different features of a media device. Each cut out is formed through an entire thickness of the conductive media case 100. For example, FIG. 1A and 1B illustrate a camera cutout 101 that is configured to expose a camera of the media device while the media device is placed within the conductive media case 100. The cut outs may include cut outs for speaker ports, charging ports, volume buttons, power buttons and any other types of components of the media device.

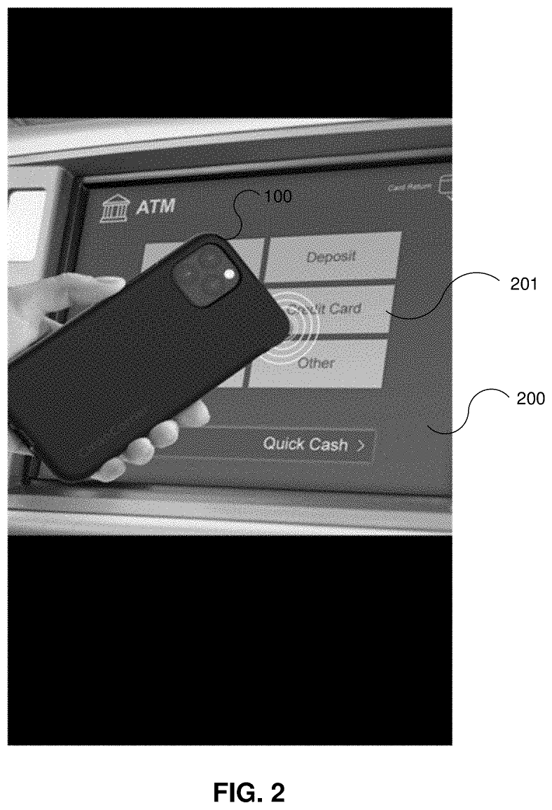

FIG. 2 illustrates an interaction between the conductive media case 100 and a capacitive based touch sensitive device 200 according to one embodiment. In the example shown in FIG. 2, the touch sensitive device 200 is a touch display of an ATM machine. As shown in FIG. 2, the conductive media case 100 is used by the user to interact with the ATM machine. The ATM machine displays various touch selectable interface elements 201 and the conductive media case 100 is used to select one of the touch selectable interface elements 201 by tapping the conductive media case 201 on the touch selectable interface element 201 of interest. The tapping includes directly contacting any portion of the conductive media case 100 (e.g., a corner or a side) with the capacitive based touch display of the ATM machine. The interaction (e.g., the tapping) and location of the interaction is sensed by the touch sensitive device 200 as a selection of a touch selectable interface element 201 at the location of the interaction. Thus, the user is able to interact with the ATM machine in this example without having to use his or hands thereby reducing exposure of bacteria to the user. Although the interaction shown in FIG. 2 is shown as using the conductive media case 100 to select touch selectable interface elements, the conductive media case 100 may also be used to input a digital signature for example.

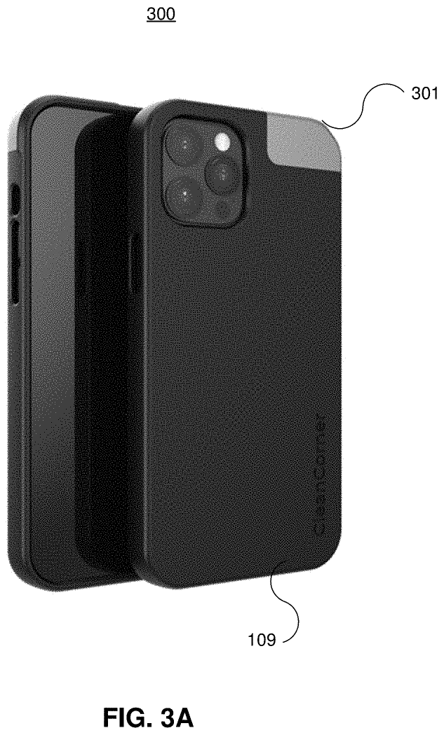

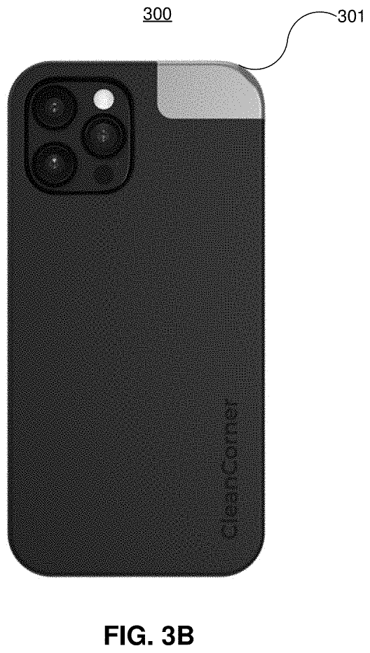

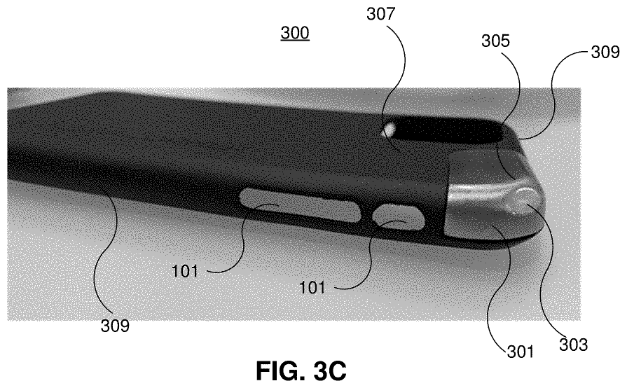

FIGS. 3A to 3C illustrate various views of a second embodiment of the conductive media case 300. The conductive media case 300 includes similar features as the first embodiment of the conductive media case. A description of the similar features is omitted for brevity.

As shown in FIGS. 3A to 3C, the conductive media case 300 includes a conductive corner attachment 301 according to the second embodiment. In one embodiment, the conductive corner attachment 301 is made of a different material from the body 109 of the conductive media case 300. Thus, the conductive media case 300 is made of multiple conductive materials that are different from each other. The conductive corner attachment 301 may be made of any metal. In one embodiment, the metal has antimicrobial properties. For example, the conductive corner attachment 301 is made of copper while the body 109 of the conductive media case 300 is made of conductive thermoplastic as previously described above. The conductive corner attachment 301 is added to the conductive media case 300 due to the antimicrobial and conductive properties of the conductive corner attachment 301.

As shown in FIG. 3C, the conductive corner attachment 301 overlaps across a portion of the exterior back surface 307 that extends from the exterior corner in which the conductive corner attachment 301 is placed, portions of a plurality of exterior edge surfaces 309 that extend from the exterior corner in which the conductive corner attachment 301 is placed, and the exterior corner. The size of the conductive corner attachment 301 may vary depending on the size of the corner of the media device that is placed in the conductive phone case. Generally, the conductive corner attachment 301 has a width that is half the width of the media device case 300.

The conductive corner attachment 301 is generally curved in shape. However, in one embodiment the conductive corner attachment 301 includes a flattened surface 303 at an edge 305 of the conductive corner attachment 301 such that the flattened surface 303 is disposed between curved surfaces of the conductive corner attachment 301. The flattened surface 303 is configured to increase the surface area of the conductive corner attachment 301 that is configured to contact touch sensitive display devices. By increasing the surface area of the conductive corner attachment 301 that contacts a touch sensitive display device, more charge can be passed through the conductive media case 300 thereby increasing a likelihood that the touch sensitive display device senses the touch made by the conductive media case 300.

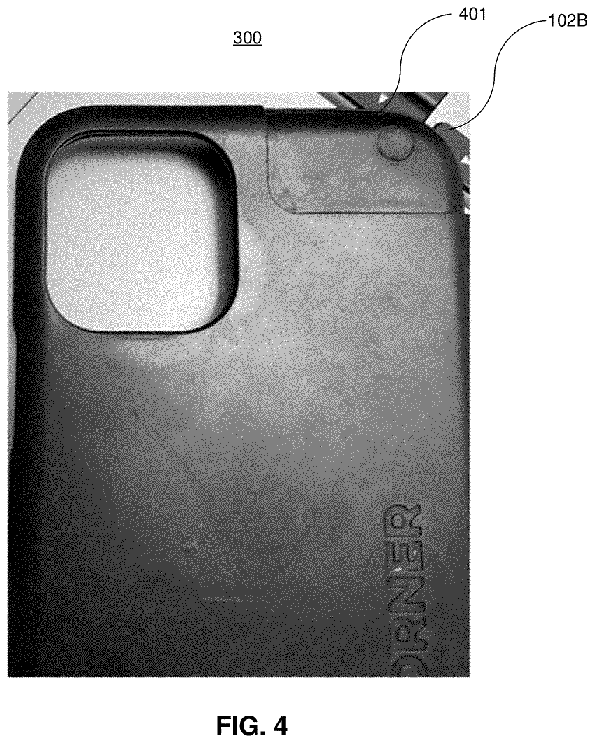

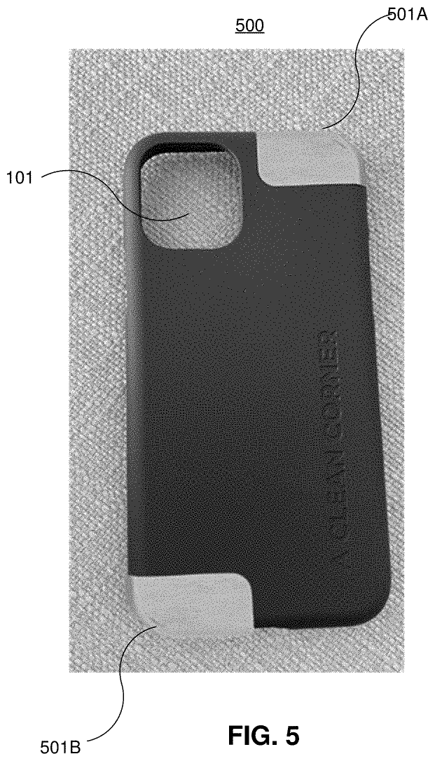

FIG. 4 illustrates one embodiment of the conductive media case 300 with the conductive corner attachment 301 removed from the conductive media case 300. As shown in FIG. 4, the conductive media case 300 includes a recessed portion 401 having a shape that matches a shape of the conductive corner attachment 301. A depth of the recessed portion 401 substantially matches a thickness of the conductive corner attachment 301 such that when the conductive corner attachment 301 is attached to the conductive media case 300 by placing the conductive corner attachment in the recessed portion 401, the exterior surfaces of the conductive corner attachment 301 are flush with the exterior surfaces of the conductive media case 300 that are made of conductive thermoplastic. In one embodiment, the conductive corner attachment 301 is attached to the recessed portion 401 using a fastener such as adhesive. Note that the recessed portion 401 extends partially through a thickness of the conductive media case 300. Although a single recessed portion 401 is formed at corner 102B of the conductive media case 300, the conductive media case 300 may have as many as four recessed portions to allow for a conductive corner attachment 301 at each of the corners of the conductive media case. FIG. 5 illustrates a third embodiment of a conductive media case 500. The third embodiment of the conductive media case 500 includes two conductive corner attachments 501A and 501B rather than a single conductive corner attachment 301 shown in the second embodiment of the conductive media case 300. As shown in FIG. 5, conductive corner attachment 501A is located at the upper right corner of the conductive media case 500 and the conductive corner attachment 501B is located at the lower left corner of the conductive media case 500. However, the conductive corner attachments 501A and 501B may be respectively located at the upper left corner and the lower right corner of the conductive media case 500.

In the embodiment with the conductive corner attachment placed at the upper left corner of the conductive media case 500, the conductive corner attachment will include a different shape than the other conductive corner attachment located at any of the other corners of the conductive media case 500 in order to account for the cutout 101. The conductive corner attachment with the different shape has less surface area than the other conductive corner attachments. Due to the cutout 101, there is less space to place a conductive corner attachment at the upper left corner of the conductive media case 500. Thus, any conductive corner attachment placed at the upper left corner that is adjacent to the cutout 101 has less surface area compared to a conductive corner attachment placed at any of the other corners of the conductive media case 500.

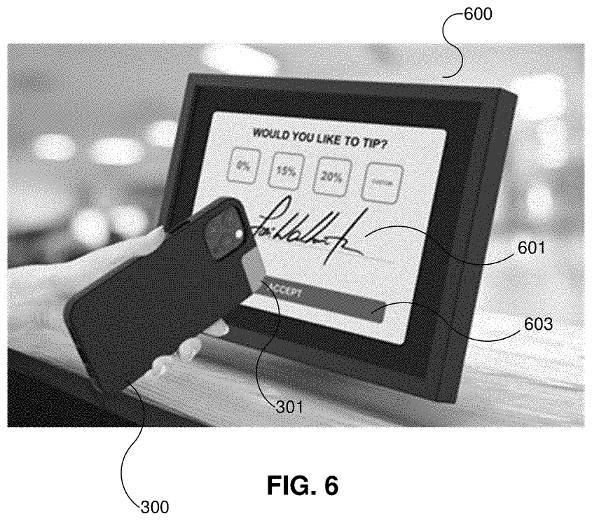

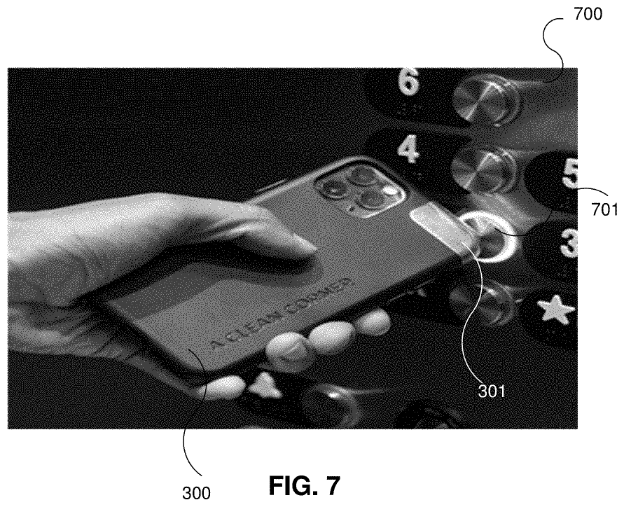

FIGS. 6 and 7 illustrate various use cases of the conductive media case 300 with the single conductive corner attachment. However, the uses cases described in FIGS. 6 through 7 are applicable to the conductive media case 500 with a plurality of conductive corner attachments as well as the conductive media case 100 without the conductive corner attachment.

FIG. 6 illustrates the conductive media case 300 used as a stylus to interact with a capacitive based touch sensitive device 600 according to one embodiment. In the example shown in FIG. 6, the user uses the conductive media case 300 as a stylus by touching the conductive corner attachment 301 on the touch sensitive display screen of the device 600 and writing the signature 601 with the conductive corner attachment 301. The advantage to using copper on the conductive corner attachment 301 is copper provides the necessary conductivity and antimicrobial properties, but allows for an even smother stylus signature. The copper conductive corner attachment glides more easily on touch screens versus other materials. After the signature 601 is entered using the conductive media case 300 and sensed by the touch sensitive device 600, the conductive media case 300 is used to accept the signature 601 by selecting a touch selectable interface element such as the “accept” user interface element 603.

FIG. 7 illustrates the conducive media case 300 being used to interact with non-capacitive based interface. In the example shown in FIG. 7, the conductive media case 300 is used to interact with buttons 701 of an elevator 700. As shown in FIG. 7, the conductive corner attachment 301 is used to press the button 701 of the elevator 700 rather than the user having to use his or her finger to press the button 701. Due to the antimicrobial features of the conductive corner attachment 301, the user need not worry about cross-contamination of any bacteria residing on the button 701.

In a fourth embodiment, a corner attachment may be attached to a conventional media case or directly to the media device itself. When attached directly to the media device itself the media device serves as a conductor that transfers the user's charge from their hand to the corner attachment. However, should the corner attachment be added to a media case made of insulator material, the user will need to directly touch part of the corner attachment in order to use the corner attachment on capacitive touch screens. The corner attachment may be a non-permanent or permanent antimicrobial attachment for one or many corners of a media device. The size of the corner attachment may vary depending on the size of the corner of the media device in which the corner attachment will be attached.

Alternatively, the corner attachment is made in a single size, but the corner attachment is malleable enough to be molded to different sizes and/or shaped corners of different media devices. Furthermore, the corner attachment may also be malleable enough to mold to media cases that house media devices. However, the width or bulk of the corner attachment does not add significant width to the media device. Likewise, the length the corner attachment that runs along the sides of the media device is minimal and does not cover any existing buttons on the media device or cause any disruptions to the features of the media device. However, because there is not a conductive full body case that can transfer the charge to the corner, the user must put their finger directly on a part of the corner when using it.

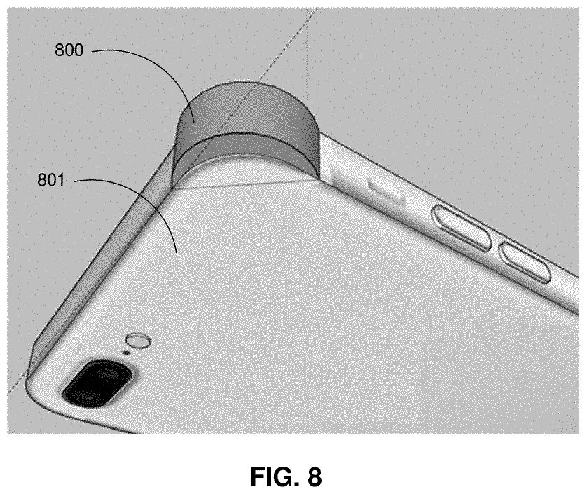

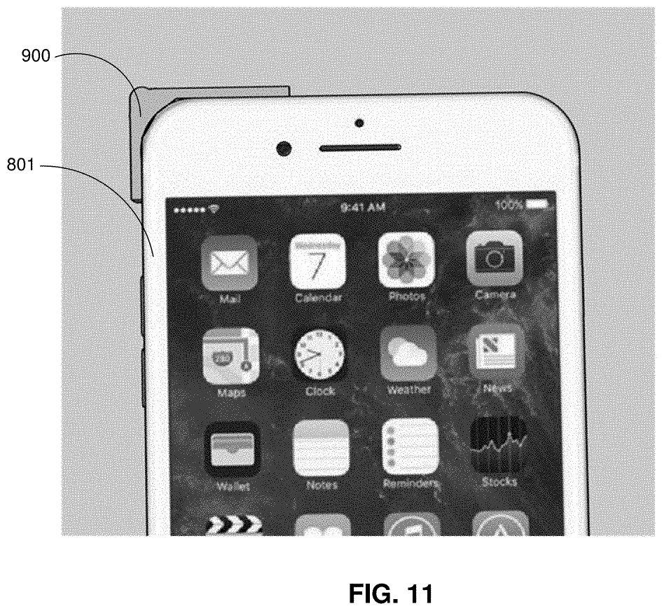

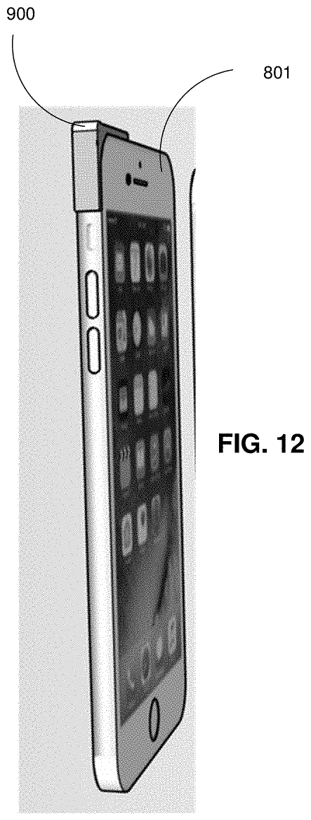

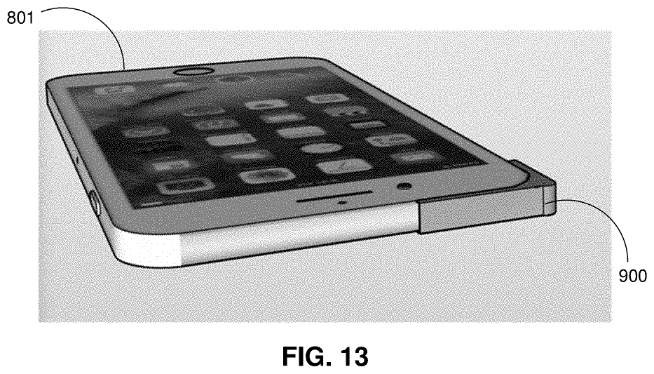

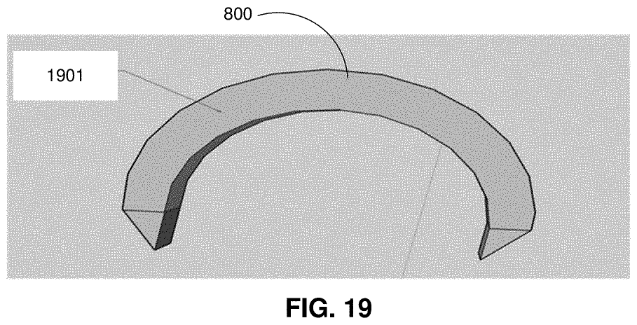

FIG. 8 illustrates one embodiment of a corner attachment 800. As shown in FIG. 8, the corner attachment 800 is attached to a corner of a media device 801. In one embodiment, the shape of the corner attachment 800 is crescent shaped as shown in FIGS. 1 and 17-19. The body of the crescent shaped corner attachment 800 shown in FIGS. 1 and 11-13 has a curved outer surface that is antimicrobial and can be used to interact with touchscreens of other devices but only if a finger is directly touching the corner allowing for the flow of charge which is awkward. (e.g., ATMs or other mobile devices).

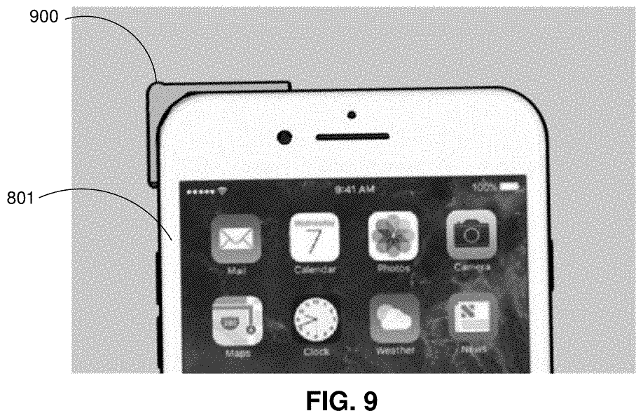

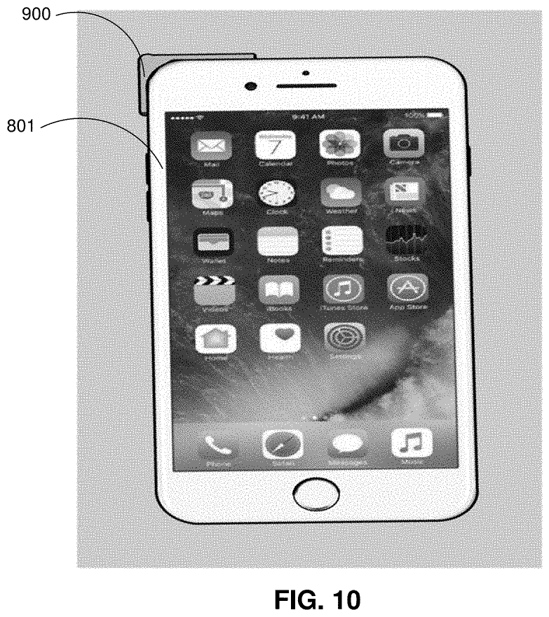

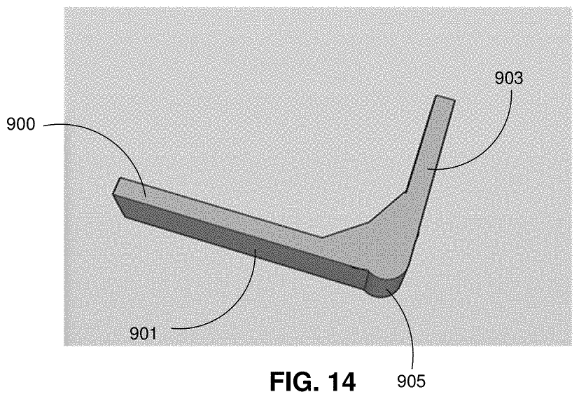

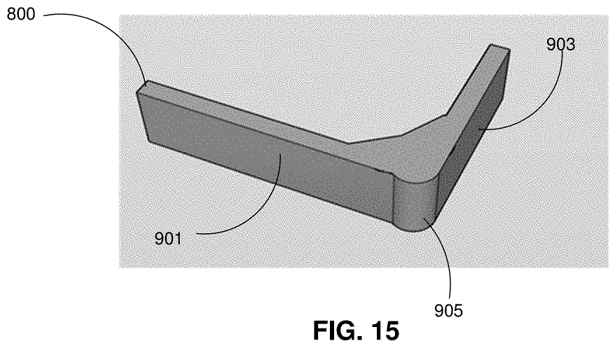

Alternatively, the corner attachment 900 has a “L” shape that “hugs” the corners of the media device 801 as shown in FIGS. 9-16. As shown in FIGS. 9-16, the body of the “L” shaped corner attachment 900 has a first part 901 that extends in a first direction and a second part 903 that extends in a second direction that intersects the first direction. A protrusion 905 is formed at the intersection of the first part 901 and the second part 903. As shown in FIGS. 14-15, the protrusion 905 has a curved surface. In one embodiment, the shape of the corner attachment 900 allows for the media device 801 to be stood upright or on the media device 801′s side without requiring the user to maintain the position of the media device 101. Thus, the media device 801 can be free standing due to the corner attachment 800 to enhance the viewing experience of the user when using the media device 801.

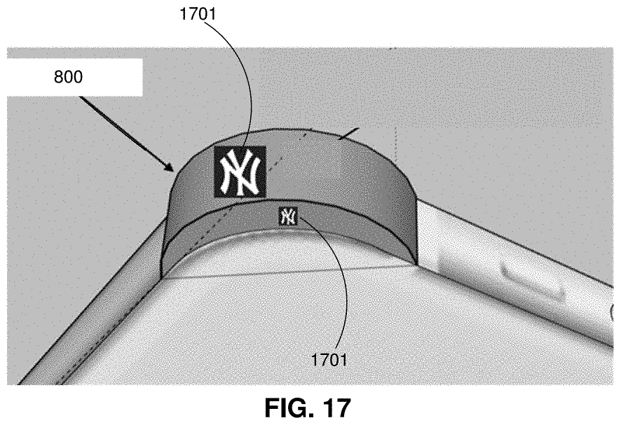

Both the crescent shaped corner attachment 800 and “L” shaped corner attachment 900 allow for easy touch screen interface while attaching seamlessly to the corner of the media device 801. Moreover, sponsors or logos 1701 can be placed on the corner attachment 800/900 as shown in FIG. 17.

The materials for the corner attachment 800/900 are antimicrobial while enabling sensed touch of touch-screen interfaces such as capacitive touch screens. In one embodiment, the material for the corner attachment 800/900 include but are not limited to brass, aluminum, copper, sponge, zinc, or any mixture of the materials or any material that enables sensed interaction with a touchscreen and is anti-microbial as described above for the embodiments of the conductive media cases. In other embodiments, the corner attachment 800/900 may enable sensed touch of touch-screen interfaces, but is not antimicrobial.

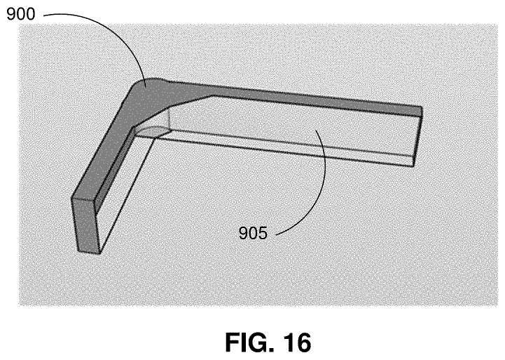

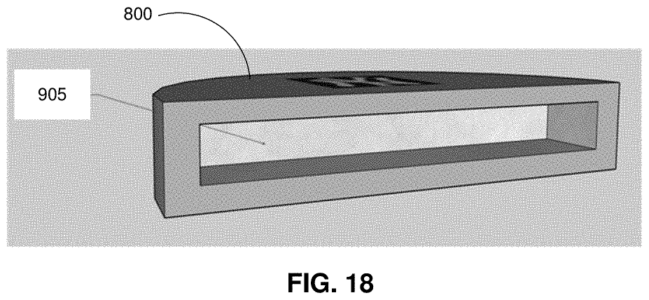

Thus, the corner attachment 800/900 is the use of an antimicrobial material on the corner of a media device 801 to allow anti-microbial interactions with touchscreens, or surfaces of any kind with less risk of interacting with virus than from using fingers etc. The corner attachment 800/900 may be attached to the corner of the media device 801 using an adhesive material 905 as shown in FIGS. 16 and 18. The adhesive material 905 is disposed on an inner surface of the corner attachment 800/900 that directly contacts the corner of the mobile device 801 to allow the corner attachment 800/900 to be attached to the corner of the media device 801.

Reference in the specification to “one embodiment” or to “an embodiment” means that a particular feature, structure, or characteristic is included in at least one embodiment of the disclosure. The appearances of the phrase “in one embodiment” or “a preferred embodiment” in various places in the specification are not necessarily referring to the same embodiment.

In the present disclosure terms such as “first,” “second,” “A,” “B” bay be used herein to describe elements of the present invention. Each of these terms is not used to define essence, order, sequence, or number of elements etc., but is used merely to distinguish the corresponding element from other elements.

While the disclosure has been particularly shown and described with reference to a preferred embodiment and several alternate embodiments, it will be understood by persons skilled in the relevant art that various changes in form and details can be made therein without departing from the spirit and scope of the invention.

What is claimed is:

1. A media device case comprising:
a conductive body including a cavity and a plurality of exterior corners external to the cavity, the conductive body configured to house a media device within the cavity of the conductive body; and
a conductive attachment attached to an exterior corner from the plurality of exterior corners of the conductive body, the conductive attachment including a conductive material that is different from a conductive material included in the conductive body;
wherein the media device case is configured to input touch to a capacitive based touch sensitive device via the conductive attachment where a location of the inputted touch is sensed by the capacitive based touch sensitive device.

2. The media device case of claim 1, wherein the conductive body further includes a plurality of interior surfaces within the cavity and one or more exterior surfaces of the media device are in direct contact with one or more of the plurality of interior surfaces of the conductive body while the media device is housed within the cavity.

3. The media device case of claim 2, wherein the plurality of interior surfaces are non-conductive, and the plurality of exterior corners and are a plurality of exterior edges that form an exterior perimeter of the media device case are conductive.

4. The media device case of claim 2, wherein the plurality of interior surfaces are conductive, and the plurality of exterior corners and are a plurality of exterior edges that form an exterior perimeter of the media device case are conductive.

5. The media device case of claim 1, wherein the conductive material included in the conductive body is conductive thermoplastic including graphite and the conductive material included in the conductive attachment is metal having antimicrobial properties.

6. The media device case of claim 5, wherein the metal having the antimicrobial properties comprises copper.

7. The media device case of claim 5, wherein the conductive thermoplastic comprises antimicrobial properties.

8. The media device case of claim 1, further comprising:
a recess at the exterior corner of the conductive body, the recess having a depth that substantially matches a thickness of the conductive attachment,
wherein the conductive attachment is attached to the recess.

9. The media device case of claim 8, wherein a shape of the recess substantially matches a shape of the conductive attachment.

10. The media device case of claim 8, wherein the conductive attachment overlaps the exterior corner, a portion of an exterior back surface of the conductive body that extends from the exterior corner, and portions of a plurality of exterior edge surfaces that extend from the exterior corner.

11. The media device case of claim 8, further comprising:
an adhesive that adheres the conductive attachment to the recess of the media device case.

12. The media device case of claim 1, wherein the conductive attachment comprises:
a flattened surface at an edge of the conductive attachment, the flattened surface increasing a surface area of the conductive attachment.

13. The media device case of claim 12, wherein the flattened surface is disposed between curved surfaces of the conductive attachment.

14. The media device case of claim 1, further comprising:
one or more additional conductive attachments attached to one or more remaining exterior corners from the plurality of exterior corners of the conductive body.

15. The media device case of claim 1, further comprising:
an exterior back surface from which the plurality of exterior corners extend,
wherein the exterior back surface is non-conductive and the plurality of exterior corners are conductive.

16. A media device case comprising:
a body including a cavity, the body configured to house a media device within the cavity of the body,
wherein the media device case is configured to input touch to a capacitive based touch sensitive device via a corner of the body where a location of the inputted touch is sensed by the capacitive based touch sensitive device.

17. The media device case of claim 16, wherein at least a first portion of the body is conductive and a second portion of the body is non-conductive, and one or more exterior surfaces of the media device are in direct contact with one or more interior surfaces of the body.

18. The media device case of claim 17, wherein the first portion of the body that is conductive comprises conductive thermoplastic including graphite.

19. The media device case of claim 16, further comprising:
one or more conductive attachments, each of the one or more conductive attachments attached to a corresponding corner of the body, the conductive attachment made of a different material from the body of the media device case.

20. The media device case of claim 16, wherein all exterior corners of the media device case are conductive and configured to input touch to the capacitive based touch sensitive device where the location of the inputted touch is sensed by the capacitive based touch sensitive device.
